(19) United States
(12) Patent Application Publication
(10) Pub. No.: US 2026/0165339 A1
(43) Pub. Date: Jun. 18, 2026

(54) Method for Producing a Beverage, Preferably for Brewing Tea, and a Device and a Mill for Carrying Out the Method

(71) Applicant: STEINER AG WEGGIS, Weggis (CH)

(72) Inventor: Adrian Steiner, Weggis (CH)

(73) Assignee: STEINER AG WEGGIS, Weggis (CH)

(21) Appl. No.: 19/171,860

(22) Filed: Apr. 7, 2025

(30) Foreign Application Priority Data
Dec. 12, 2024 (CH) 001375/2024

(51) Int. Cl. A23F 3/18; A23F 3/12; A47J 31/00; A47J 31/40; A47J 31/42; A47J 31/46; A47J 31/52; A47J 31/60; A47J 42/16; A47J 42/18; A47J 42/20; A47J 42/40; A47J 42/50; A47J 42/56

(52) U.S. Cl. CPC A23F 3/18; A23F 3/12; A47J 31/002; A47J 31/405; A47J 31/42; A47J 31/461; A47J 31/469; A47J 31/5251; A47J 31/60; A47J 42/16; A47J 42/18; A47J 42/20; A47J 42/40; A47J 42/50; A47J 42/56

(57) ABSTRACT

Method for producing a beverage in which milled tea leaves as tea powder or another powder are conveyed into a brewing chamber and water for the brewing process is added. Tea powder is delivered through a filling opening at a cylinder, and water is delivered through a delivery line into the closed brewing chamber. Brewing takes place as a first brewing phase, followed by a pause phase for the extracted tea beverage in the brewing chamber for a specific period of time. The brewed beverage is conveyed to an outlet. This is followed by at least one second brewing phase by repeat delivery of hot water through the delivery line into the brewing chamber, with the powder remaining therein. The brewed beverage is again allowed a pause phase for a specific dwell time in the brewing chamber, and then the beverage is conveyed to the outlet.

### FIELD OF THE INVENTION

The invention relates to a method for producing a beverage, in particular for brewing tea, wherein the ground tea leaves are introduced as tea powder into a brewing chamber, water for the brewing process is then added, and the extracted beverage is preferably conveyed to an outlet, as well as a device and a mill for carrying out the method.

### BACKGROUND OF THE INVENTION

A device for carrying out a method for the brewing of tea according to the printed publication JP 2004118680 A1 comprises a tealeaf container for receiving tea leaves, a mill for producing comminuted tea leaves, and a dispensing device for dispensing a predetermined quantity of comminuted tea leaves from this container body. Also provided is a hot-water tank with a solenoid valve for dispensing a predetermined quantity of hot water. In addition, a tea beverage extractor is provided for preparing the tea beverage, through which the brewed tea beverage is conveyed to a cup. The intention is that a rapid preparation of a tea beverage should therefore be made possible. With such a preparation with this tea beverage extractor there is the disadvantage that the extracted tea beverage cannot be optimally exploited in the development of the taste.

Disclosed in the printed publication EP 2 810 592 A1, which corresponds to U.S. Pat. No. 9,622,618, is a coffee mill, wherein the two interacting milling disks are mounted above one another in a mill body, wherein the lower milling disk can be rotated about a vertical axis of rotation, while the upper milling disk does not rotate, and can be adjusted by an eccentric shaft relative to the lower milling disk in the direction of the axis of rotation. This fixed milling disk is arranged in a milling disk carrier which can be displaced axially in the mill body, and the eccentric shaft is guided horizontally through the milling disk carrier. Accordingly, the milling disk carrier is mounted such as to be movable upwards and downwards in the vertical direction by means of the eccentric shaft. In order to allow for this amount of movement, it is to the purpose for the eccentric shaft to be provided on both sides with axially cylindrical shaft parts, which are guided in corresponding holes in the mill body. With the use of such a finely adjustable mill for milling tea leaves in particular, however, the eccentric shaft extending horizontally through the milling disk carrier may impede the passage of the milled material.

The invention is based on the object of providing a method for producing a beverage, preferably for brewing tea, by means of which a preferred beverage taste development is achieved but without a substantially long time being required from the moment of starting the tea preparation with the milling, the subsequent extraction process, and through to the filling of the container, such as a cup.

### OBJECTS AND SUMMARY OF THE INVENTION

According to the invention, during the brewing process after the introduction of the tea powder and of the hot water into the brewing chamber, brewing takes place as a first brewing phase, then a pause phase for a specific period of time in the brewing chamber, and then the brewed tea beverage is conveyed to the outlet. This is then followed by at least one second brewing phase by the introduction of cold, warm, or hot water into the brewing chamber with the tea powder remaining therein, and then the brewed tea beverage is again left for a pause phase for a particular dwell time in the brewing chamber, and then likewise conveyed to the outlet.

With this brewing process according to the invention it is possible, in a very efficient manner, for a very tasty tea beverage to be prepared, regardless of the type of tea and the condition of the tea leaves.

After the brewing and releasing of the extracted tea beverage, the brewing chamber is opened and the used tea powder is conveyed into a catchment container.

Very advantageously, next at least one procedure of pouring back of flushing water takes place into the brewing chamber, which has been closed again. The tea powder residue which is released by this pouring process and the flushing water are likewise preferably conveyed into the catchment container by opening the brewing chamber again.

By means of this back-pouring process it can be ensured that the brewing device is always once again brought into the cleaned state required for carrying out the method after each brewing process, because the tea powder is inclined during brewing to remain adhering to the inner walls of the brewing chamber.

Further advantageously, after the back-pouring, a forwards-pouring process is carried out in the brewing chamber, now in the closed state, wherein flushing water is conveyed, as during the brewing process, into the brewing chamber via the first piston, and is then conveyed away at the outlet as waste water.

With the method according to the invention, during each of the at least two brewing phases, in each case just such a quantity of water is introduced into the brewing chamber in a controlled manner that a container is filled at the outlet, such as a tea cup, in two or more part fillings, depending on the number of brewing phases, with interruptions, which then continues until the predetermined total quantity in the container is achieved.

The brewing device for carrying out the method explained heretofore is provided with an axially displaceable cylinder with at least one filling opening for the tea powder, and in these two pistons, forming a closable brewing chamber and moveable relative to one another. A delivery line for hot water leads through the first piston, and the other second piston is formed from a sieve and is fluid-connected to an outlet. The preferably freshly ground tea powder can be conveyed into this brewing chamber, and the first piston can be moved against the second piston at least partially inside the cylinder.

The invention provides for a control valve to be actuated in the delivery line for the hot water through the first piston, and a control valve in the line connection to the outlet, actuated by a control unit. At the start of brewing, first tea powder and then hot water, in specific quantities, are conveyed into the brewing chamber, and based on the predetermined amount of time detected by the control unit of a respective pause phase of the brewed tea beverage, the brewing process is controlled accordingly.

To the purpose, assigned to the brewing device is a mill with at least two interacting mill disks, which in particular serve to mill tea leaves filled into a tea container, of which preferably the one mill disk can be rotated by means of a drive, wherein the milled tea leaves can be conveyed as tea powder through the at least one filling opening of the cylinder and into the brewing chamber.

According to the invention, the tea container is configured in a funnel shape tapering downwards into a milling chamber, and from this to the milling disks, by which the rotatable milling disk is rotationally connected to a mixing element, which preferably extends upwards through this milling space as far as into the tea container, and, during milling, carries out a rotational movement together with the milling disk, as a result of which the tea leaves are stirred and aligned correctly for the subsequent milling process.

### BRIEF DESCRIPTION OF THE DRAWINGS

The invention and its further advantages are explained in great detail on the basis of exemplary embodiments and by making reference to the drawings. The Figures show:

FIGS. 1, 2, 3 and 4, in each case, show a longitudinal section of a brewing unit, in particular of tea powder, in four different positions for carrying out the method according to the invention;

FIG. 5 shows a longitudinal section through a mill with the tea container on the upper side;

FIG. 6 shows a partially enlarged longitudinal section through the mill; and

FIG. 7 shows a hydraulic schematic diagram of the brewing unit, with the delivery line for the water, the outlet of the tea beverage, and the control valves of a control unit.

### DETAILED DESCRIPTION OF THE INVENTION

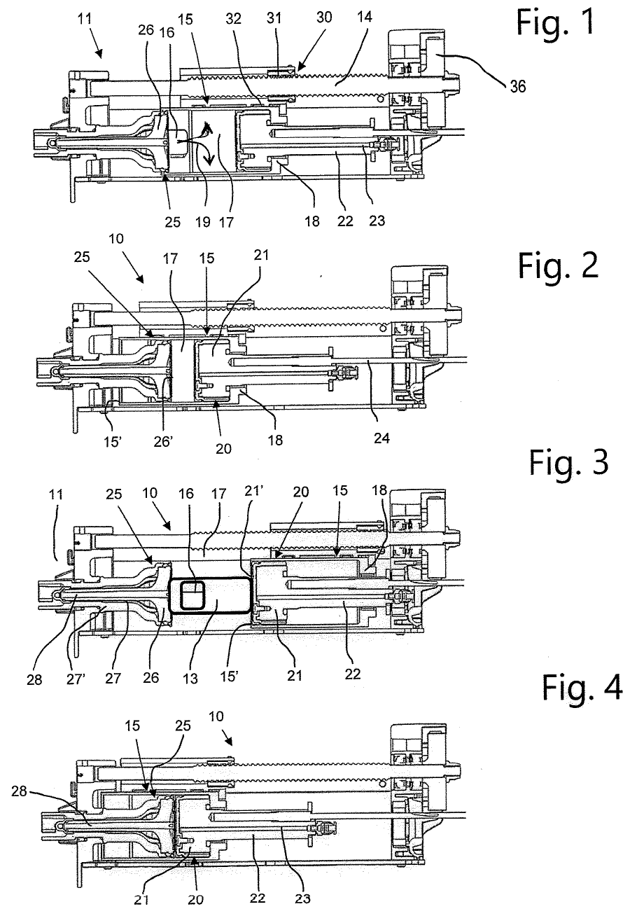

FIG. 1 to FIG. 4 show a brewing unit 10 of a brewing device, which is configured in particular for the extracting of tea powder. The brewing device can be integrated in an independent device, in a coffee machine, or in an automatic beverage dispenser, and it has at least one outlet, at which the beverage can be filled into a container 35, such as a tea pot, a cup, or the like.

For the beverage which is to be produced, use can be made, as well as the known varieties of tea, also of a mixture of tea leaves and other leaves, or of taste powders. The tea which is to be produced can of course be mixed with other taste additives, such as lemon juice or other juices, rum, or others, mechanically or by hand.

With the brewing device, it is of course possible for other powders or brewing materials similar to powders to be used, such as powder from coffee, cascara, lupins, medicinal herbs etc., or mixtures thereof. Advantageously, brewing takes place with hot water, but can likewise take place with cold or warm water.

The brewing unit 10 of the brewing device is provided with an axially movable cylinder 15, with at least one filling opening 16 for the tea powder and/or other powders, and, forming in this a closable brewing chamber 17, two pistons 20, 25, movable in relation to one another. The cylinder 15 is mounted such as to be movable by a linear drive 30 in an adjustable manner in a frame housing 11 of the brewing unit 10. Provided at the linear drive 30 is a rotatably mounted spindle 14, with a nut 31 mounted on it, which is coupled to the cylinder 15 by a connecting element 32. At a rotation of the rotatable spindle 14, which can be controlled by a drive, the nut 31 is adjusted together with the cylinder 15 into the corresponding controlled position.

The first piston 20 is provided with a piston head 21, mounted in cylinder 15, and a piston shaft 22. The cylinder 15 comprises a sleeve collar 18, engaging around the piston head 21, which is mounted so as to be adjustable on the piston shaft 22. A deliver line 23 passes through this first piston 20, for hot water for the brewing, which opens on the front side at the piston head 21 into the brewing chamber 17. Moreover, a heating cartridge 24 is integrated in the piston shaft 22, by means of which preheating is effected of the piston 20 and therefore also of the brewing chamber. In a simpler embodiment, however, this heating cartridge can be done without.

The second piston 25, located opposite the first piston 20, is arranged stationary in the frame housing 11 of the brewing unit 10, and comprises a sieve 26′, adjoining the brewing chamber 17, a piston head 26 holding this, a piston shaft 27, and an outlet line 28 fluid-connected to an outlet 33. This second piston 25 is surrounded by an isolating outer casing 27′. It could of course be configured differently than as represented, such as without this outer casing.

According to the invention, the method for producing the tea beverage takes place in the following steps:
Delivery of the tea powder 19 indicated takes place through the filling opening 16 at the cylinder 15, then pressing, and delivery of the hot water through the delivery line 23 into the brewing chamber 17, and
brewing takes place as a first brewing phase,
followed by a pause phase for the extracted tea beverage in the brewing chamber 17 for a specific period of time, and
then the brewed tea beverage is conveyed to the outlet 33,
this is then followed by at least one second brewing phase by the repeat delivery of hot water through the delivery line 23 into the brewing chamber 17, with the tea powder remaining therein,
and the brewed tea is again allowed a pause phase for a specific dwell time in the brewing chamber 17,
and then the tea beverage is likewise conveyed to the outlet 33.

Within the framework of the invention, these brewing and pause phases can be repeated more than twice, depending on the circumstances, wherein, with the same procedure, in each case hot, cold, or warm water is delivered into the brewing chamber 17, and tea powder remaining therein is repeatedly brewed, then left to draw, and the tea beverage extracted in this way is then discharged. This takes place preferably with an outlet 33 closed. Such an at least third brewing and pause phase can be actuated in a controlled manner if, for example, a larger quantity than a cupful is being provided.

The respective time spans of the pause phases after the brewing phases are set at the same or at different lengths. In this way, with at least two brewing phases, the first pause phase takes place with a shorter time span than the second in a controlled manner, since, at the first pause phase, a more rapid extraction of the freshly filled tea powder takes place than at the second brewing phase. These time spans during brewing can be seconds, until the hot water has saturated the powder, while by contrast the drawing or the pause phase respectively can last, depending on the setting, from 10 seconds to up to a minute.

At each of the at least two brewing phases during the brewing process, in each case such a quantity of water is delivered in a controlled manner that a container 35 at the outlet, such as a teacup, is filled in two or more part fillings, depending on the number of brewing phases with interruptions, until the predetermined total quantity in the container is attained. In principle, it would also be possible, after the brewing phases have been carried out, for the tea powder to be removed and new tea powder again being introduced, and the brewing phases then being repeated until the container 35 is filled.

After the last of the two or more brewing processes and the discharge of the extracted tea beverage, the brewing chamber 17 is opened, and the used tea powder is conveyed into a catchment container, not shown in any greater detail. Next, at least one back flushing of flushing water takes place, from the outlet, through the second piston 25, and into the brewing chamber 17 which is again closed, wherein the two pistons are positioned approximately as during brewing. The tea powder residue, released by the back flushing, and the flushing water which is let in are conveyed through an opening in the brewing chamber 17 likewise preferably into the catchment chamber.

It would also be possible to proceed in such a way that a respective back flushing could take place by way of several pressure surges or the like of flushing water, and/or that such a back flushing is not carried out after each completed filling of the container, but after a specific number of filled containers in each case after several brewing and pause phases, which could be determined according to experience.

After the back flushing, advantageously a forwards flushing takes place in the brewing chamber 17, which is in the closed state, wherein, as with brewing, flushing water is conveyed from the first piston 20 and through the brewing chamber 17, and then conveyed away through the outlet line 28 of the piston 25 and a waste water line 39 into a catchment container 41. The forwards flushing could also be carried out by several pressure surges of flushing water or the like, and/or not after every completed filling of the container, but likewise after a specific number of container fillings.

As a representation of the individual method steps, these are explained as follows in FIG. 1 to FIG. 4:

FIG. 1 shows the open position of the brewing unit 10, wherein the cylinder 15 is moved with its front end 15′ as far as over the second piston 25, while the first piston 20 is in contact at the rear sleeve collar 18 of the cylinder 15, and the filling opening 16, projecting into the brewing chamber 17 is placed in the cylinder wall in front of the second piston 25. This filling opening 16 connects on the inlet side to the outlet opening of the mill 50, not shown in any greater detail, such that freshly milled tea powder 19 can be delivered in metered amounts.

FIG. 2 shows the brewing position of the brewing unit 10, with the filled tea powder 19. The cylinder 15 is pushed forwards together with the first piston 20 against the second piston 25, in such a way that the tea powder 19 is located in between them without pressing, or it can be pressed, wherein, if pressing of the tea powder is intended to take place in the brewing chamber before and during the brewing at a low pressure and in a controlled manner, the pressure should be low and correspond approximately to atmospheric pressure, but, depending on the application, it can also be set higher. The cylinder 15 is pushed forwards with its front end 15′ as far as the outer circumference of the second piston 25, sufficiently far for it to cover the filling opening 16. The first piston 20 comes in contact at the rear sleeve collar 18 of the cylinder 15, and is pushed forwards by this into the pressing position.

According to the method according to the invention, with the brewing and pause phases in this brewing position, according to FIG. 3 the cylinder 15 and the first piston 20 in the frame housing 11 of the brewing unit 10 are drawn back, the brewing chamber 17 is fully opened, and the used tea powder can fall downwards, for example into a catchment container. In this situation, the cylinder 15 is pushed back against the first piston 20 so far that the front face side 21′ of the piston head 21 projects as least as far as the front end 15′ of the cylinder, such that any remaining powder residue on the inside of the cylinder is pushed out by the piston 20. Moreover, the filling opening 16 at a frame part 13 can be seen laterally in the frame housing 11.

FIG. 4 shows the brewing unit 10 in the frontmost position of the cylinder 15 and of the first piston 20, wherein the two pistons 20, 25 are in contact with their face sides. In this position, the forwards flushing advantageously takes place, wherein the flushing water is conveyed through the delivery line 23 of the first piston 20, through the sieve 26′ which is to be cleaned, and the outlet line 28 of the piston 25, and then into a waste water line 39 and into a catchment container 41.

FIG. 7 shows the control arrangement of the method according to the invention, wherein a control valve 42 in the delivery line 43 for the hot water and a control valve 44 in the line connection 45 to the outlet 33 can be actuated by a control unit 40, by means of which the start of brewing of the tea powder, delivered in specific amounts into the brewing chamber 17 of the brewing unit and the hot water, and, based on the predetermined time period detected by the control unit of a respective stirring or pause phase of the tea beverage which is to be produced, the brewing process can be controlled or regulated accordingly.

During the back flushing, the control valve 42 for the water delivery is switched by the control unit 40 in such a way that the water can be conveyed via a back flushing line 47 through the second piston 25 into the brewing chamber 17, wherein the brewing chamber can be adjusted from the closed state by the axial movement of the cylinder 15, by the control unit 40, into an opened position, in order for the tea powder residue released by the back flushing and the flushing water introduced are preferably released into the catchment container.

At the forwards flushing, with the brewing chamber closed, as is shown in FIG. 4, the control valve 42 in the delivery line 43 for the flushing water, and a control valve 46 of a line connection 39 to a catchment container 41, are opened by the control unit 40, but not the control valve 44 to the outlet, in order to allow a specific quantity of water through the pistons 20, 25, to be received in the catchment container 41.

As a further variant, it would be possible, during the pause phase, during which the water dwells in the brewing chamber 17, for a circulation of the water from the brewing chamber by means of a pump and back into the chamber to take place, in order to enhance the extraction of the beverage.

Advantageously, arranged in the delivery line 43 for the water is an actuator element for the delivery quantity of the water, and preferably several pressure sensors in the brewing chamber 17, in order for the pressure of the medium during brewing to be determined, and for a comparison with a reference value to be sent to the control unit 40, wherein, in the event of a deviation from the reference pressure, the actuator element can be controlled and actuated accordingly in order to attain constant pressure conditions during the brewing in the brewing chamber. The actuator element can be a proportional valve, another quantity-regulating element, a volume-controlled pump, or the like. Such an actuator element is advantageously also suitable for the brewing of coffee.

The volumes of the brewing chamber 17 when in the brewing position, as well as of the tea powder and water contained in it, are specified for the brewing in a specific proportion to each other, which are detected by the control unit 40, by means of which the control valve 42 in the delivery line 43 for the hot water can be actuated, as well as a closure valve in a passage opening for delivering the tea powder into the at least one filling opening 16 in the cylinder 15. The quantity of tea powder can, however, also be determined by the time duration of the milling.

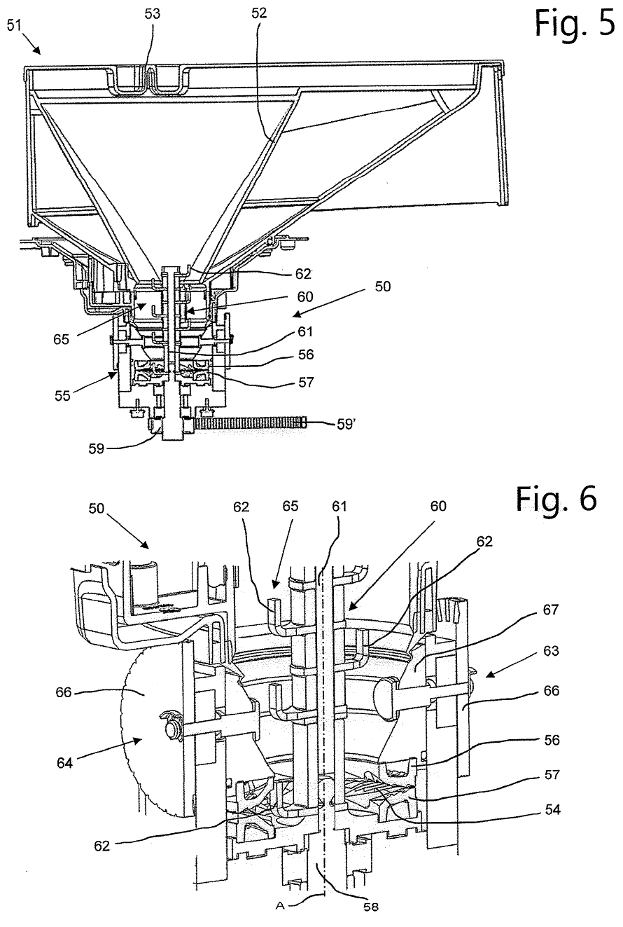

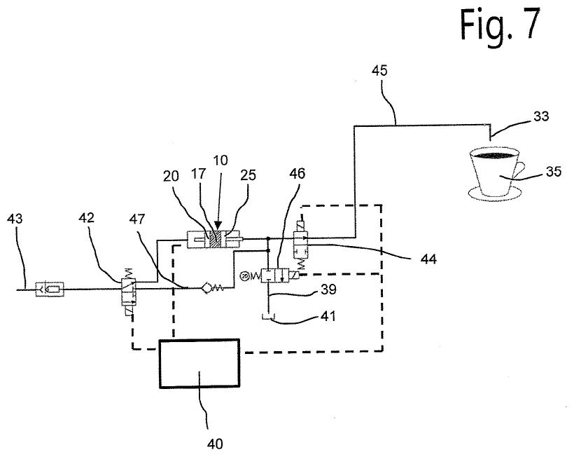

FIG. 5 and FIG. 6 show a mill 50 of the brewing device, which serves for the milling in particular of the tea leaves filled into a tea container 51. This comprises a mill housing 55, on which the tea container 51 is placed, secured but detachably, and in which are mounted two interacting milling disks 56, 57, of which the lower milling disk 57 can be rotated by a rotary motor with a drive shaft 58, wherein a pinion 59 and a toothed belt 59′ for connecting to the rotary motor can be seen. The tea container 51 is configured with a funnel shape 52 tapering downwards, which leads into a milling space 65, and from this to the milling disks 56, 57 arranged on the under side. The funnel shape 52 is preferably configured at an acute angle against the vertical, for example between 15 and 30°, in order for the tea leaves to drop downwards uniformly and not to remain hanging.

According to the invention, this mill 50 is provided with a mixing element 60, which is rotatably connected to the rotatable mill disk 57, wherein this extends preferably through the milling space 65 upwards as far as the lower part of the tea container 51, and during milling carries out the rotational movement together with the one milling disk 57. This mixing element 60 could also be arranged as rotatable by means of a separate drive or a bearing arrangement provided in the mill housing 55.

With this mixing element 60, the tea leaves filled into the tea container 51 and in the milling space 65 are detached from one another by a mixing procedure, and aligned correctly for the milling procedure which follows. As a result, the tea leaves are conveyed in an optimum manner downwards between the milling disks. This minimizes the resistance and favours a frictionless transition and delivery flow inside into the milling disks. The rotatable milling disk 57, and therefore the mixing element 60, can be rotated, for example, at a revolution speed of up to 1,000 revolutions per minute.

The mixing element 60 consists of a rotating shaft 61, running coaxially to the milling disk 57 and connected to the drive shaft 58, with driver elements 62 distributed projecting along its circumference. These driver elements 62 are configured in each case as hook-shaped grippers, running radially outwards, which in each case are arranged above one another and offset at an angle of 180° to one another. In this situation they are arranged along the vertical rotating shaft 61 in such a way that each driver element 62 follows another. They could of course be configured other than as shown, such as, for example, straight or curved bolts projecting away from one another, or in the form of a worm conveyor. The milling space 65 is dimensioned wide enough in diameter for the tea leaves to move successively downwards.

The interacting milling disks 56, 57 can be adjusted by an adjustment mechanism 63, 64 in relation to one another along the axis of rotation A, in order to change the degree of milling of the milled material which they cut. This adjustment mechanism 63, 64, preferably provided on opposing sides of the milling housing 55 with adjustment means 66, comprises a sleeve body 67 in the milling space 65, secured in a replaceable manner to the under side of which is the fixed milling disk 56. By a manual rotation of at least the one adjustment means 66, by way of an eccentric element, not shown in greater details, the sleeve body 67, and with it the milling disk 56, are adjusted in the direction of the axis of rotation A. This adjustment of the degree of milling could also be carried out by an electrical control device, although not shown.

The specific delivery quantities of the tea powder into the brewing unit 10 can be regulated by the time duration of the milling, but provision could also be made for a quantity regulator by means of a flap, a slide element, or the like.

The milling disks 56, 57, configured as rings with U-shaped cross-sections, are in each case aligned approximately radially, with a plurality of teeth 54 on their face surfaces facing one another. The teeth 54 are provided with sharp cutting elements, in order for the tea leaves to be cut and not crushed. These teeth 54, aligned approximately radially, are shaped as slightly rounded along their cutting surfaces, and are arranged in rows at specific distance intervals. To the purpose, these cutting surfaces, viewed together in cross-section, form a V-shaped inlet, in order for the tea leaves to be carried outwards from the milling space 65. The milling disks 56, 57, are configured in such a way that, during the milling process, they create only minimal friction heat. This is important in order to obtain the sensitive aromas and etheric oils of the tea leaves.

The tea holder 51, configured in a funnel shape tapering downwards, is provided on its upper side with a removable protective cover 53, for example a lattice structure, which has the effect that the operating personnel, when loading tea leaves, only need to place their fingers into the tea container to a limited degree, such that they cannot come in contact with the rotating mixing element.

The invention has been adequately described by way of the foregoing exemplary embodiments. It could, however, also be explained and illustrated by further variants. For example, with the lines provided for, line systems with multiple part-lines could also be used. With regard to the medium as water, cold, warm, or hot water could also be used, and there is no restriction to hot water, even if hot water is indicated. Exactly the same applies with the provision of tea as powder or beverage, whereby other substances, such as coffee etc., can be used.

1. Method for producing a beverage, preferably for the brewing of tea, wherein milled tea leaves as tea powder or another powder are conveyed into a brewing chamber and water for the brewing process is added, and the extracted beverage is preferably conveyed to an outlet, the method comprising:
delivery of the tea powder takes place through the filling opening at the cylinder, then pressing, and delivery of the hot water through the delivery line into the brewing chamber, and
brewing takes place as a first brewing phase,
followed by a pause phase for the extracted tea beverage in the brewing chamber for a specific period of time, and
wherein the brewed tea beverage is conveyed to the outlet,
this is then followed by at least one second brewing phase by the repeat delivery of hot water through the delivery line into the brewing chamber, with the tea powder remaining therein, and the brewed beverage is again allowed a pause phase for a specific dwell time in the brewing chamber, and then
the beverage is likewise conveyed to the outlet.

2. Method according to claim 1, wherein after the brewing and the dispensing of the extracted tea beverage, the brewing chamber is opened, and the used tea powder is conveyed into a catchment container, and then at least one back flushing of flushing water takes place from the outlet into the brewing chamber which has been closed again, and that the flushing water which has been inlet is conveyed through an opening of the brewing chamber likewise into the catchment container.

3. Method according to claim 1, wherein, after the back flushing, a forwards flushing takes place in the brewing chamber, which is in the closed state, wherein flushing water is conveyed through the brewing chamber and is then discharged at the outlet as waste water.

4. Method according to claim 2, wherein the water is conveyed during the back flushing through a second piston, formed from a sieve, for the discharge of the tea liquid after the brewing into the brewing chamber, wherein the brewing chamber in the closed state is formed by this piston, a movable cylinder surrounding it, and a first piston partially guided in it, wherein the latter is formed with the delivery line of the water and can be moved relative to the other piston.

5. Method according to claim 3, wherein during the forwards flushing, a specific quantity of water is conveyed through the first piston with the water delivery for the brewing into the brewing chamber, and then through the second piston provided with the sieve or formed as such, and conveyed away as waste water.

6. Method according to claim 1, wherein the respective time spans of the pause phases after the respective brewing phases are determined in each case as the same or different.

7. Method according to claim 1, wherein at each of the at least two brewing phases, in each case such a quantity of water is delivered into the brewing chamber that a container at the outlet, such as a teacup, is filled in two or more part fillings, depending on the number of brewing phases with interruptions, which is continued until the specified total quantity in the container is attained.

8. Method according to claim 1, wherein if pressing of the tea powder in the brewing chamber takes place before and during the brewing at a low pressure in a controlled manner, this pressure then corresponds approximately to atmospheric pressure.

9. Method according to claim 1, wherein during the pause phase, wherein the water dwells in the brewing chamber, a circulation of the water takes place from the brewing chamber by means of a pump and then back again, in order to enhance the extraction of the beverage.

10. Brewing device for carrying out the method according to claim 1, which is provided with an axially movable cylinder with at least one filling opening for the tea powder, and two pistons forming in this a closable brewing chamber, movable relative to one another, of which at least the first piston is connected to a delivery line for water, and the other second piston comprises a sieve, and is fluid-connected to an outlet, wherein in particular the tea powder can be conveyed into the brewing chamber and at least the first piston can be moved against the second piston at least partially inside the cylinder, wherein a respective control valve in the delivery line for the water can be actuated by the first piston, and in the line connection for the outlet by a control unit, by means of which, at the start of brewing, powder and hot water can be conveyed in specific quantities into the brewing chamber, and, based on the specified time duration of a respective pause phase of the brewed beverage as detected by the control unit, the brewing process is controlled accordingly.

11. Brewing device according to claim 10, wherein the control valve for the water delivery is switched during the back flushing by the control unit, in such a way that the water can be conveyed by the second piston via a back flushing line into the brewing chamber, wherein the brewing chamber can be adjusted from the closed state, by the axial movement of the cylinder due to the control unit, into an opened position, in order to flush the tea powder residue released during back flushing, and the flushing water delivered, preferably into the catchment container.

12. Brewing device according to claim 10, wherein during a forwards flushing with the brewing chamber closed, control valves in the delivery line for the hot water and the line connection from the control unit are opened, in order to allow a specific water quantity through the pistons and to be received preferably in a catchment container.

13. Brewing device according to claim 10, wherein arranged at the delivery line for the hot water is an actuator element for the delivery of the water, and preferably several pressure sensors in the brewing chamber, in order to determine the pressure during brewing and sending this to the control unit for comparison with a reference value, wherein, in the event of a deviation, this actuator element can be controlled accordingly, in order to achieve controlled pressure conditions in the brewing chamber during brewing which are monitored at all times, wherein this is particularly well-suited for the brewing of coffee.

14. Brewing device according to claim 10, wherein the volumes of the brewing chamber located in the brewing position, and of the tea powder filled into this, and of the water for the brewing, are specified as being in a particular relationship to one another, which are detected by the control unit, and by this unit the control valve in the delivery line for the water, as well as preferably a valve in a passage opening for controlling the delivery quantity of the tea powder into the at least one filling opening in the cylinder, can be actuated.

15. Mill, for the brewing device according to claim 10, which is provided for the milling in particular of the tea leaves filled into a tea container, with at least two interacting milling disks, of which preferably the one milling disk can be rotated by a drive, wherein the milled material can be guided through at least one filling opening in the cylinder into the brewing chamber, wherein the tea container, configured as a funnel shape tapering downwards, leads into a milling space, and from this to the milling disks, of which the rotatable milling disk is rotatably connected to a mixing element, which preferably extends upwards through the milling space as far as the tea container, and during milling carries out a rotation movement together with the one milling disk, by means of which the tea leaves are stirred, or that this mixing element is arranged such as to be rotatable by means of a separate drive or a bearing arrangement provided in the milling housing.

16. Mill according to claim 15, wherein the mixing element is formed from a rotating shaft, running coaxially to the milling disk and connected to it, with driver elements distributed projecting along its circumference.

17. Mill according to claim 15, wherein the tea container, configured as a funnel shape tapering downwards, is provided on its upper side with a protective cover, which has the effect that the operating personnel, when loading tea leaves, can only reach with their fingers in a restricted manner into the tea container.

18. Mill according to claim 15, wherein the interacting milling disks can be adjusted by an adjustment mechanism in relation to one another along the axis of rotation, in order to change the degree of milling of the milling material being cut by these disks.

19. Milling disk for a mill according to claim 15, wherein the milling disks comprise a plurality of teeth on their face surfaces facing one another, which are aligned approximately radially and in this situation are configured as transverse to the axis of rotation, or that these cutting surfaces, seen together in cross-section, form a V-shaped inlet, wherein the teeth are provided with sharp cutting elements in order for the tea leaves to be cut and not crushed.

20. Milling disk according to claim 19, wherein the teeth aligned approximately radially are arranged in rows at specific distance intervals, and are slightly rounded along their cutting surfaces.
